(19) United States
(12) Patent Application Publication
(10) Pub. No.: US 2025/0040760 A1
(43) Pub. Date: Feb. 6, 2025

(54) FLAT BURR COFFEE BEAN GRINDER

(71) Applicant: Velimir GENOV, Lombar, IL (US)

(72) Inventor: Velimir GENOV, Lombar, IL (US)

(21) Appl. No.: 18/771,661

(22) Filed: Jul. 12, 2024

Related U.S. Application Data
(60) Provisional application No. 63/513,643, filed on Jul. 14, 2023.

(51) Int. Cl. A47J 42/20; A47J 42/16; A47J 42/18; A47J 42/46; A47J 42/50

(52) U.S. Cl. CPC A47J 42/20; A47J 42/16; A47J 42/18; A47J 42/46; A47J 42/50

(57) ABSTRACT

The present disclosure surrounds a flat burr grinder with increased ease of maintenance, adjustability, and/or precision as related to the grinding of media such as coffee beans. The apparatus described herein includes a grinding assembly which is optionally configured for disassembly at a location which corresponds to the location of the burrs to allow for easier maintenance and adjustability without affecting the gap between the burrs as last set by the user. An optionally interchangeable pre-breaker auger allows for adjustability of the particulate size of grinding material which is introduced to the burrs for grinding.

### CROSS-REFERENCE TO RELATED APPLICATIONS

This application claims the benefit of U.S. Provisional Application No. 63/513,643, filed Jul. 14, 2023, the content of which is herein incorporated by reference in its entirety for all purposes.

### FIELD OF THE INVENTION

The present disclosure is directed to a flat burr coffee bean grinder which is configured to provide a consistent and precisely adjustable grinding of coffee beans for steeping in beverages.

### BACKGROUND OF THE INVENTION

Coffee is steeped from ground coffee beans roasted to a desired flavor profile. The consumption of coffee as a beverage dates back centuries wherein it most began as a delivery vehicle for caffeine. However, drinking caffeine now carries leisurely and social connotations wherein flavors are meticulously crafted and curated by connoisseurs and those engaging in social interactions alike.

The crafting of coffee carries endless variables from sourcing beans, roasting beans, grinding beans, and steeping methodologies. Each of these sequential steps can greatly impact the flavor and quality of the resulting coffee drink, particularly in the case of espresso. Espresso is considered by many as the purist distillation of the coffee bean, and is the most recognizable form of coffee drinks worldwide.

Coffee, and particularly espresso drinks, are directly affected by the particulate size of coffee grounds, and the consistency of the coffee grounds. For instance, a low precision coffee grinder may result in coffee grounds which are too large or too small. Coffee grounds which are too large result in under-extraction, wherein enough surface area has not been provided for the desired steeping methodology and the steeping results in a weak or light coffee lacking robust flavors and deep rich color. Coffee grounds which are too small result in over-extraction which results in a bitter flavor, and undersized coffee may seep through the filter system resulting in a gritty beverage. Understandably, the precision and consistency in which coffee beans are ground have great impact on the resulting beverage.

Accordingly, the ability to provide an accurate and precise manner to grind coffee beans is of utmost importance to the quality of coffee beverage. While many variations of coffee grinders exist which the teachings of the present disclosure are applicable, including flat burr grinders and conical burr grinders, the present disclosure focuses on the use of flat burr type grinders. Widely seen as the superior configuration, flat burr grinders provide a more consistent and precise grind over alternatives. However, flat burr grinders exhibit challenges associated with alignment and dialing in for a desired grind. These challenges multiply as one must separate the burrs for cleaning, maintenance, and replacement. Thus, the alignment and dialing in process must be repeated each time a user disassembles the burr grinder.

Accordingly, there exists an identified need for an improved burr grinder which provides simpler and more consistent assembly, disassembly and reassembly.

### SUMMARY OF THE INVENTION

Certain embodiments of the present disclosure comprise a burr grinder assembly which is adapted for ease of disassembly, maintenance, and reassembly wherein the reassembled burr grinder assembly produces consistent similar grinding results as compared to grinding results prior to disassembly. Commonly disassembly results in a compounding error created by multiple varying tolerances between assembled parts. The present disclosure reduces compounding errors by limiting the number of modules which require disassembly in order to access the burrs. It is an aspect of certain embodiments to provide a grinder assembly wherein the removal of a single adjustment assembly unit provides access to the burrs for rapid and simple removal and maintenance of the burrs.

The present disclosure comprises a first burr which is located more medially within the apparatus in relation to a second burr which is distally offset from the first burr. The first burr is held stationary in relation to the apparatus, and the second burr is configured to rotate in relation to the first burr. The burrs comprise cutting surfaces which are adapted to face each other wherein the closer the cutting surfaces are to one another, the finer the particulate size when grinding coffee or other objects. The first burr is statically constrained to the grinder assembly, and the second burr is interconnected to a spindle which is driven by the motor assembly. The connection between the spindle and the motor comprises a spring, wherein the spring is configured to apply a force to the spindle configured to push the second burr distally outward and away from the first burr. The adjustment assembly, when interconnected to the burr grinder, opposes the force enacted by the spring on the rotary carriage by pressing the spindle, and thus the second burr, toward the first burr. Thus, the adjustment assembly provides force to compress the spring and thus set the gap between the first burr and the second burr.

In certain embodiments the adjustment assembly comprises an adjustment knob which is configured to advance a thrust plate medially inward or distally outward. The thrust plate freely rotates and thus is able to rotate with the spindle when the thrust plate of the adjustment assembly is in contact with the spindle. When the adjustment knob of the adjustment assembly is rotated in a first direction, the thrust plate of the adjustment assembly travels in a medial direction. Thus, pressing against the spindle which reduces the burr gap and results in finer particulate. When the knob of the adjustment assembly is rotated in a second direction, the thrust plate of the adjustment assembly travels distally. Thus, allowing the spindle to travel distally due to the force applied by the spring, increases the burr gap and results in coarser particulate.

It is an aspect of certain embodiments to allow ease of removal of the burrs. In certain embodiments the first burr is constrained to the grinder assembly through the use of locator pins which extend axially away from the back of the first burr. The pins are configured to be magnetic or ferromagnetic wherein the interconnection between the first burr and the apparatus comprises a magnetic connection between the burr gear and the grinder assembly. The benefit of the pins (e.g., magnetic, and/or non-magnetic) allows for the consistent, precise, and/or repeatable mounting of the burrs wherein the magnetic connection beds the burrs into place without the need for specialized tools.

It is an aspect of certain embodiments of the present disclosure to pre-break coffee beans prior to entry into the interstitial space between the burrs of the grinding apparatus. Without pre-breaking, the coffee beans may be too large to enter the interstitial space between the burrs. Without pre-breaking, coffee beans may be lodged at the entrance of the burrs wherein they are ground down to finer particulate than is desired until the remaining portion of the coffee bean is small enough to enter the interstitial space between the burrs. The fine particulate results in a more bitter and potent steeping of coffee than is desired. Pre-breaking breaks the coffee beans into smaller portions which are able to enter into the interstitial space between the burrs upon introduction to the burrs, and thus reduces the production of fine particulates.

It is an aspect of certain embodiments to allow the modular swapping of an auger. The changing of an auger can be used to adjust feed rate between an input port and the burrs based on the pitch of the screw or “flighting” of the auger. Furthermore, the changing of an auger can allow for the use of an auger with larger diameter, smaller diameter, or tapering diameter to increase or decrease particle sizes of coffee beans prior to introduction to the burrs for grinding. Additionally or alternatively, the auger is optionally used to break the material (e.g., coffee beans) into smaller particles prior to introduction to the burrs for grinding.

These and other advantages will be apparent from the disclosure contained herein. The above-described embodiments, objectives, and configurations are neither complete nor exhaustive. As will be appreciated, other embodiments are possible using, alone or in combination, one or more of the features set forth above or described in detail below. Further, this Summary is neither intended nor should it be construed as being representative of the full extent and scope of the present disclosure. The present disclosure is set forth in various levels of detail in this Summary, as well as in the attached drawings and the detailed description below, and no limitation as to the scope of the present disclosure is intended to either the inclusion or non-inclusion of elements, components, etc. in this Summary. Additional aspects of the present disclosure will become more readily apparent from the detailed description, particularly when taken together with the drawings, and the claims provided herein.

### BRIEF DESCRIPTION OF THE DRAWINGS

FIG. 1A—A perspective view of certain embodiments of a grinding apparatus

FIG. 1B—A side view of certain embodiments of a grinding apparatus

FIG. 1C—A front view of certain embodiments of a grinding apparatus

FIG. 1D—A cross-sectional view of certain embodiments of the grinding apparatus shown in FIG. 1C

FIG. 2—An exploded perspective view of certain embodiments of a grinding apparatus

FIG. 3—An exploded perspective view of certain embodiments comprising flat burrs

FIG. 4A—A side view of certain embodiments of a grinding apparatus comprising a grinding assembly

FIG. 4B—A front view of certain embodiments of a grinding apparatus comprising a grinding assembly

FIG. 4C—A section view the grinding apparatus shown in FIG. 4B

FIG. 5—An exploded perspective view of a grinding assembly of certain embodiments

FIG. 6A—A perspective view of a pre-breaking chamber of certain embodiments

FIG. 6B—A side view of a pre-breaking chamber of certain embodiments

FIG. 6C—A section view of the pre-breaking chamber shown in FIG. 6B

FIG. 6D—A section view of the pre-breaking chamber shown in FIG. 6B

FIG. 7A—A side view of an adjustment assembly of certain embodiments

FIG. 7B—A front view of an adjustment assembly of certain embodiments

FIG. 7C—A section view of the adjustment assembly shown in FIG. 7B

FIG. 8—An exploded perspective view of an adjustment assembly of certain embodiments

FIG. 9A—An exploded perspective view of certain embodiments wherein flat burrs are interconnected to the apparatus with magnetic connection

FIG. 9B—An exploded perspective view of certain embodiments wherein flat burrs are interconnected to the apparatus with magnetic connection

### DETAILED DESCRIPTION OF VARIOUS EMBODIMENTS

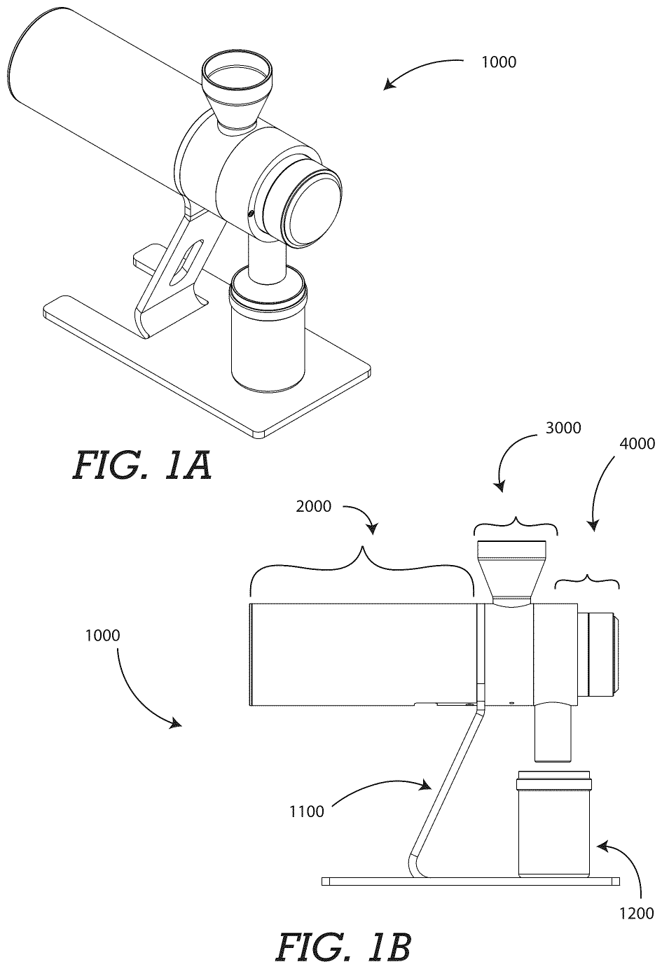

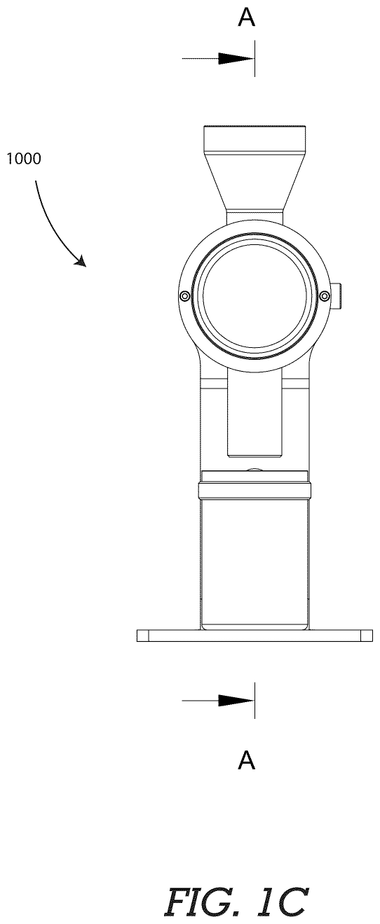

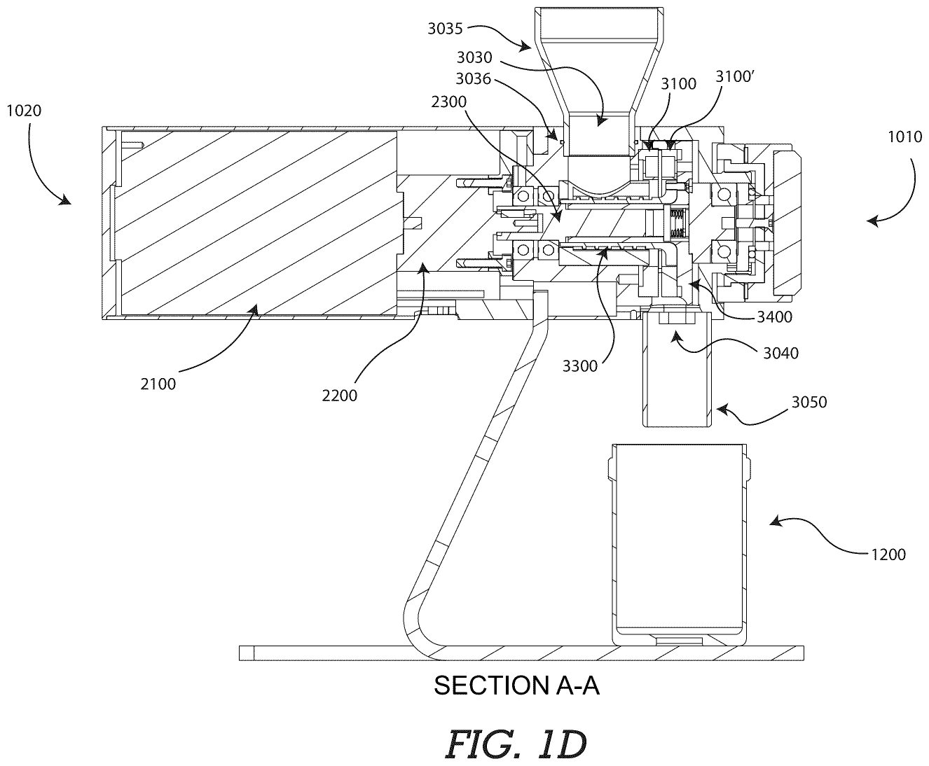

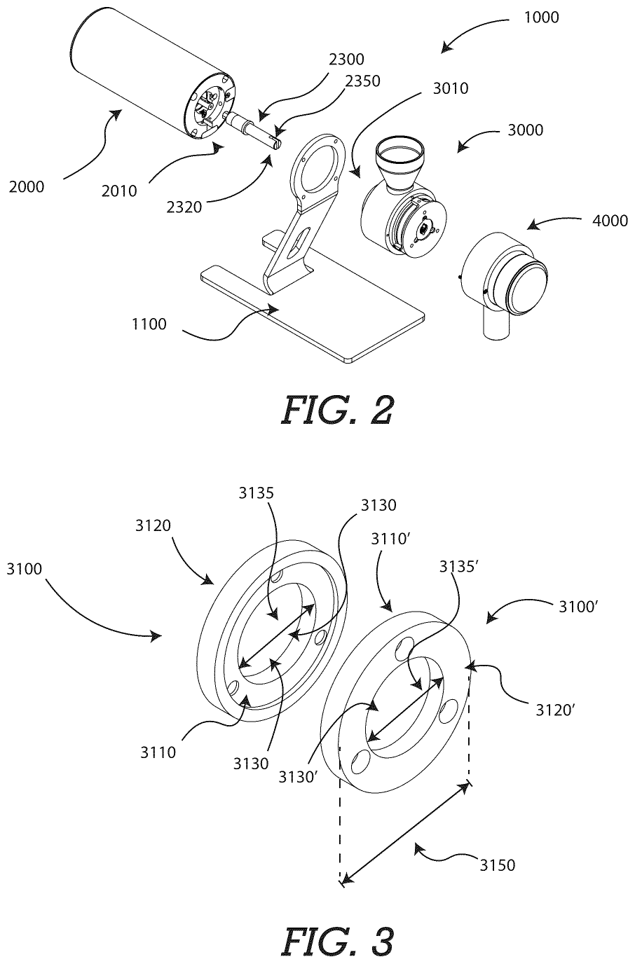

Certain embodiments of the present disclosure, as shown in FIG. 1A-FIG. 2 for instance, comprise a grinding apparatus 1000 intended for the grinding of coffee beans and similar material. The apparatus 1000 comprises a base 1100, driveline 2000, a grinding assembly 3000, and an adjustment assembly 4000.

The driveline 2000 of certain embodiments comprises a motor 2100, and a gearbox 2200. Interconnected to the driveline 2000 is a drive-shaft 2300 configured to transmit the rotation and torque of the driveline 2000 to the grinding assembly 3000. In certain embodiments, a proximal aspect 2010 of the driveline assembly is interconnected with a proximal aspect 3010 of the grinding assembly wherein the base 1100 is interconnected therebetween.

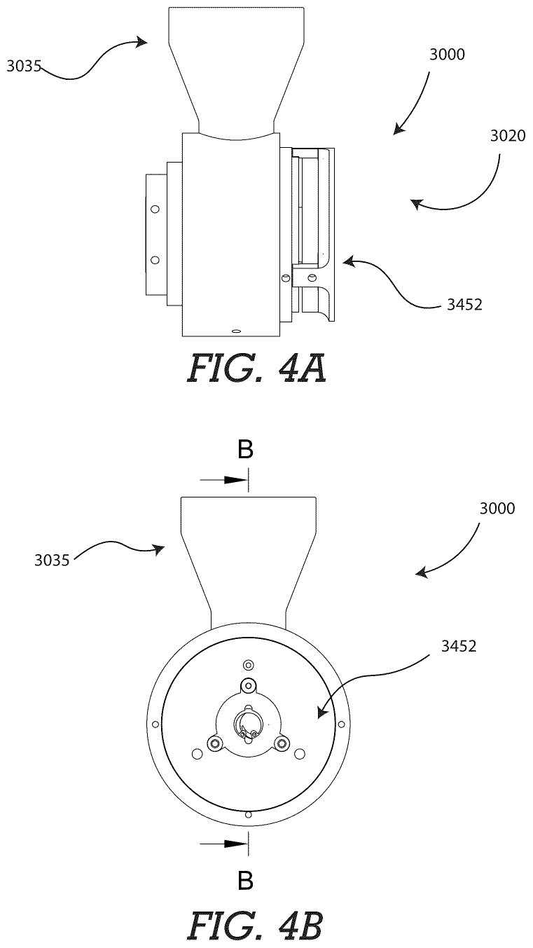

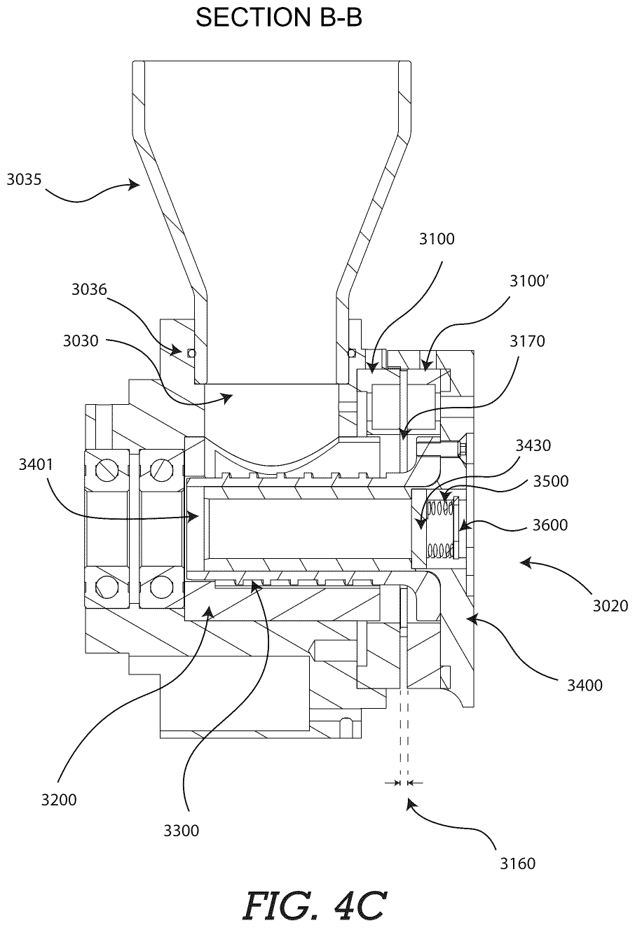

In certain embodiments, as shown in FIG. 1C-FIG. 5 for instance, the apparatus 1000 comprises a grinding assembly 3000 interconnected to a driveline 2000. In certain embodiments, the grinding assembly 3000 comprises flat-burrs 3110, 3120 for the grinding of coffee beans. The grinding assembly 3000 comprises an input port 3030 through a top medial aspect of the grinding assembly wherethrough the material for grinding—such as coffee beans—are introduced within the apparatus 1000. The input port 3030 is optionally configured in a gravity fed configuration (e.g., vertical configuration such as shown in FIG. 4C for instance), and the pathway of the pre-breaking chamber is optionally configured in a laterally transporting (e.g., horizontal configuration) wherein the material is transported by the auger laterally from the input port, through the pre-breaking chamber, and to the burrs for grinding. The input port 3030 leads into a pre-breaking chamber 3200 which comprises a pathway 3230 configured to house an auger 3300 extending therethrough. The pre-breaking chamber is configured to break material (e.g., coffee beans) between the pathway 3230 and the prior to the material being introduced between the burrs within the burr-gap for grinding. Pre-breaking the material prior to grinding increases post-grinding particulate (e.g., ground coffee beans) size consistency (e.g., ground coffee beans), and reduces maintenance related downtime such as related to material particulate clogging the burrs. When the auger 3300 is rotated, material received through the input port 3030 is advanced toward a first flat burr 3100 and a second flat burr 3100′. Each burr 3100 comprises a cutting surface 3110 for grinding material and mounting surface 3120 opposite the cutting surface 3110, wherein the mounting surface 3120 is adapted for interconnecting the burrs 3100 to apparatus 1000. The flat burrs 3100 comprise cutting surfaces 3110 which are oriented toward each other such that material advanced between the burrs 3100 are ground by the cutting surfaces 3110. The first burr 3100, located more medially than the second burr 3100′, is statically mounted within the grinding assembly 3000, and the second burr 3100′ rotates in relation to the first burr 3100. While embodiments disclosed herein comprise a stationary first burr and a rotating second burr, alternate embodiments wherein both burrs rotate, or wherein the first burr rotates and the second burr is held static, are each within the spirit and scope of the present disclosure.

In certain embodiments, a funnel 3035 is configured to interconnect with the input port 3030 wherein coffee beans or other material for grinding can be poured through the funnel 3035 and into the input port 3030. Further, the funnel 3035 is configured to be removably interconnected with the input port allowing a user to remove the funnel for purposes including maintenance, cleaning, or installation of a larger or smaller funnel. In certain embodiments, the funnel is slidably interconnected within the input port wherein an O-ring 3036 maintains the connection between the funnel 3035 and the input port 3030. The O-ring 3036 provides a sliding friction fit which prevents the accidental removal of the funnel 3035, and reduces sounds due to rattling due to vibration between the funnel 3035 and input port 3030. Accordingly, the funnel is able to be removed and reinstalled without the use of tools. Alternate embodiments which employ differing strategies to interconnect the funnel to the input port are within the spirit and scope of the present disclosure.

In certain embodiments the burrs 3100 comprise a 64 mm outer diameter 3150, however embodiments comprising burrs of varying dimension are within the spirit and scope of the present disclosure.

In certain embodiments, as shown in FIG. 3-FIG. 5 for instance, the cutting surfaces 3110 of the first burr and the second burr are separated by a distance referred to as a burr gap 3160. The burr gap 3160 is measured as the smallest distance between opposing cutting surfaces 3110. In certain embodiments, the cutting surfaces 3110 of the burrs comprise a concave shape which are oriented toward each other. Accordingly, the burr gap 3160 is measured at the radial extent of the burrs in such embodiments. As the material enters the interstitial space 3170 between the burrs, the cutting surfaces 3110 grind the material to smaller particles. As the material is ground to smaller particulate matter, the particles are directed radially outward. As the particles are ground to a dimension smaller than the burr gap 3160, the particles escape through the burr gap 3160 and out of the interstitial space 3170. Once the particles escape through the burr gap 3170, the ground material falls through an output port 3040 and into a collection container 1200 for use in coffee making or as otherwise appropriate.

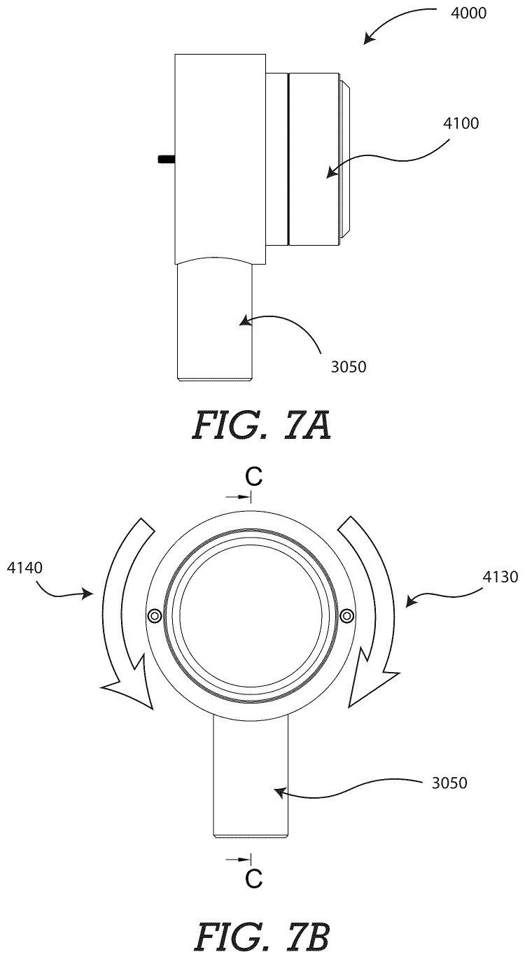

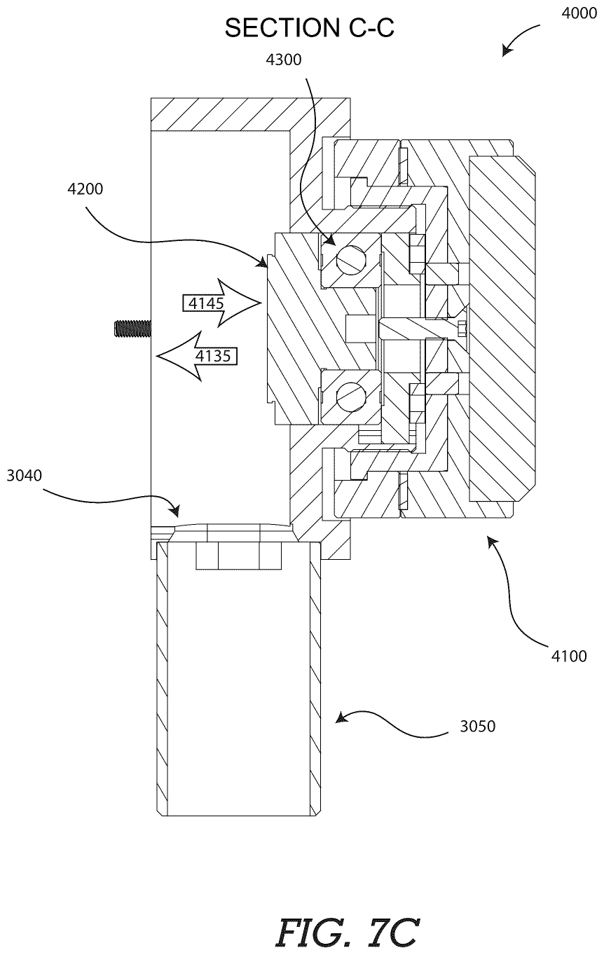

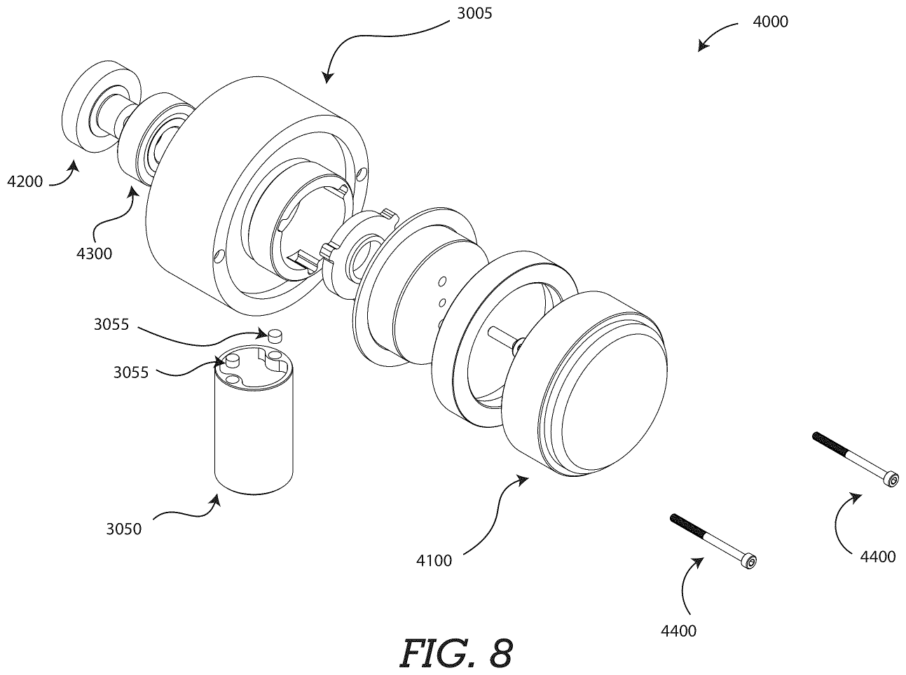

In certain embodiments, as shown in FIG. 1C-FIG. 1D and FIG. 7A-FIG. 8 for instance, an output tube 3050 which is configured to interconnect with the output port. The output tube 3050 extends downwards such that ground particulate is directed downward and prevented from being cast in lateral directions away from the collection container. In certain embodiments the output tube 3050 is interconnected with the grinding apparatus 1000 through the use of magnets 3055 to allow increased modularity and ability to easily remove the output tube 3050 without the use of tools.

In certain embodiments, as shown in FIG. 3-FIG. 5 for instance, the first burr 3100 comprises an aperture 3130 with a diameter 3135 greater than an external diameter 3330 of the auger, wherein the auger 3300 is configured to transport material for grinding from the input port 3030 and into the interstitial space 3170 between the burrs. In certain embodiments the auger 3300 is interconnected with a spindle 3400 wherein the spindle 3400 is interconnected with the driveline 2000, wherein the rotation of the motor 3100 results in the rotation of the spindle 3400 and auger 3300. Furthermore, the second burr 3100′ is interconnected with the spindle 3400, wherein the rotation of the spindle 3400 rotates the second burr 3100′ in relation to the first burr 3100. In certain embodiments the driveshaft 2300 is interconnected with the spindle 3400, wherein the driveshaft 2300 transmits the torque from the driveline 2000 to the spindle 3400 and thereby to the auger 3300 and second burr 3100′.

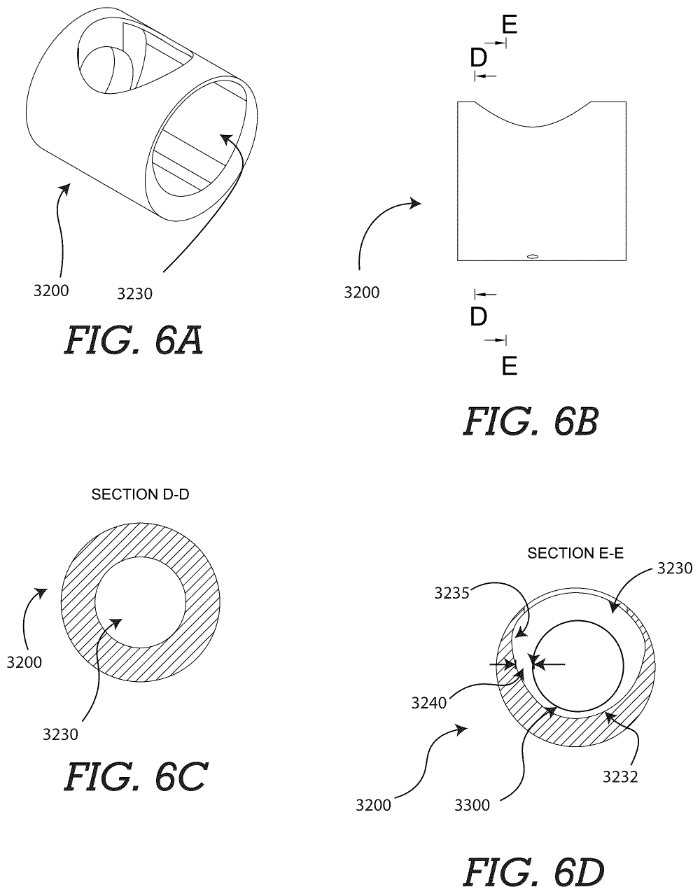

In certain embodiments, as shown in FIG. 4A-FIG. 6D for instance, the auger 3300 traverses longitudinally through a pathway 3230 of the pre-breaking chamber 3200 which extends between the input port 3030 and the burrs 3100. As shown in FIG. 4C for instance, the pre-breaking chamber is optionally located such that the material (e.g., coffee beans) passes through the pre-breaking chamber prior to being introduced to the burrs for grinding. The input port 3030 extends through the outer housing 3005 of the grinding assembly and through the pre-breaking chamber 3200. The auger 3300 is configured to transport material inserted through the input port 3030 to the burrs 3100 for grinding. In certain embodiments, the auger 3300 is eccentrically located in relation to the pathway 3230 (e.g., axially offset, for example as shown in FIG. 6D, toward the bottom aspect 3232 of the pathway), thus resulting in an asymmetrical offset between the auger 3300 and the pathway 3230. Additionally or alternatively, the auger is optionally offset toward the top, left, right, and/or bottom of the pathway. The offset of the auger 3300 within the pathway results in coffee beans to be carried downward within the pathway 3230 wherein they bind between the auger 3300 and the pre-breaking chamber 3200. This binding is advantageous particularly with coffee beans as the coffee beans will bind between the auger 3300 and the pathway 3230 and result in breakage of the coffee beans into smaller portions prior to entry between the burrs 3100. The pre-breaking of coffee beans results in a more rapid grinding process, results in more consistent particulate size. Due to the pre-breaking of the coffee beans, the fragmented coffee beans are more appropriately sized to fit between the burrs 3100 when first introduced to the burrs 3100. For the aforementioned reasons, the pre-breaking of the coffee beans also reduces fine particulate which would otherwise result in a more bitter beverage when steeped.

Certain embodiments of the present disclosure, shown in FIG. 6A-FIG. 6D for instance, comprise an asymmetric pathway 3230, and in certain embodiments cross-section of the pathway of certain embodiments comprises tapered form resembling a rounded triangle, such as a Reauleaux triangle or circular triangle, with a vertex oriented downward. The shape of the pathway 3230 is optimized to allow the transfer of material between the input port 3030 and the burrs 3100, wherein as the internal walls 3235 of the pathway taper toward the auger 3300. The tapering results in a reduction of distance 3240 between the auger 3300 and the walls 3235 of the pathway result in the material binding between the auger 3300 and the internal walls 3235 of the pathway.

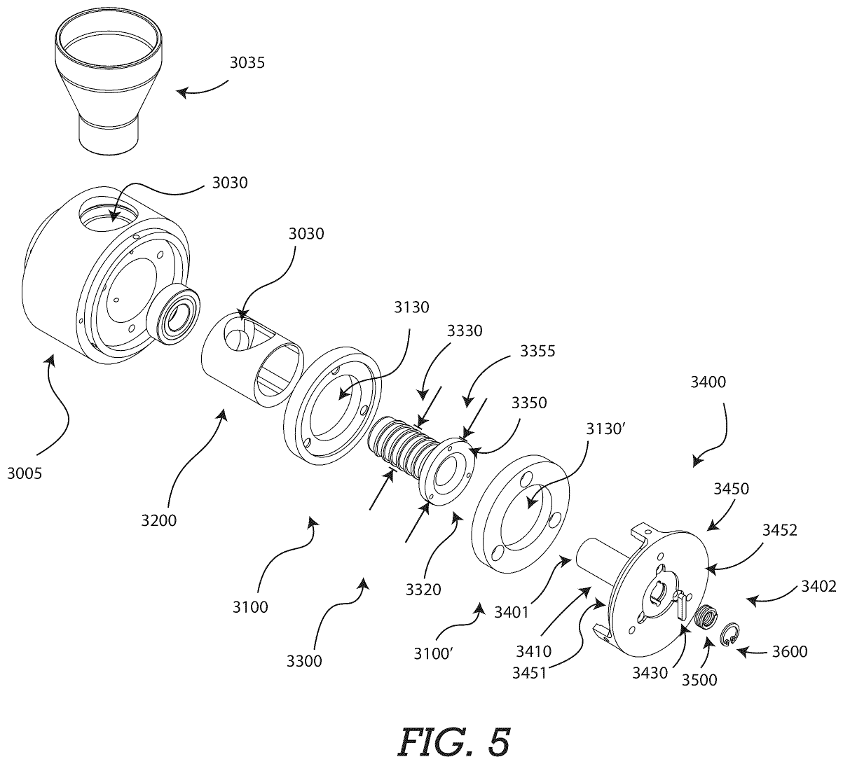

In certain embodiments, shown in FIG. 4A-FIG. 5 for instance, the spindle 3400 comprises a proximal portion 3410 having an elongated and/or tubular portion (e.g., circular cross section, and/or non-circular cross section) wherein the auger 3300, also comprising a tubular form in some embodiments, is configured to slidably interconnect over the proximal portion 3410 of the spindle, thereby interconnecting auger 3300 to the spindle 3400. The proximal portion 3410 of the spindle is configured to slidably interconnect with the driveshaft 2300 wherein the driveshaft 2300 is received within a proximal end 3401 of the spindle. The spindle 3400 further comprises a keyed element 3430 within the tubular portion of the spindle configured to interconnect with a keyed element 2350 at a distal portion 2302 of the driveshaft. When the keyed element 2350 of the driveshaft and the keyed element 3430 of the spindle are interconnected, the spindle 3400 is rotatively coupled to the drive shaft 2300.

In certain embodiments the spindle further comprises a mounting feature (e.g., a flange 3450) extending radially outward away from a distal portion 3420 of the spindle. The flange 3450 is configured to interconnect with a distal portion 3320 of the auger. In certain embodiments, the distal portion 3320 of the auger comprises a flange 3350 adapted for interconnecting to the proximal surface 3451 of the flange of the spindle. The proximal surface 3451 of the flange is further configured to interconnect with the mounting surface 3120′ of the second burr wherein the aperture 3130′ of the second burr comprises a diameter 3135′ greater than a diameter 3355 of the flange of the auger. When fully assembled, the tubular portion of the spindle 3400 extends through the aperture 3130 of the first burr, and through the aperture 3130′ of the second burr, wherein the second burr 3100′ is interconnected to the proximal face 3151 of the flange of the spindle.

In certain embodiments, shown in FIG. 4A-FIG. 5 for instance, a spring 3500 is disposed between the distal portion of the drive shaft 2320 and the distal portion of the spindle 3402. In certain embodiments as shown, the spring 3500 is captive between the keyed element 3430 of the spindle and a retainer 3600, wherein the retainer 3600 is distally located in relation to the keyed element 3430 of the spindle, wherein the interconnection of the spindle 3400 to the driveshaft 2300 engages the spring. Thus, the spring 3500 is configured to apply a force to the spindle 3400 to bias the spindle 3400 toward the front 1010 of the apparatus. Resultantly, the spindle 3400, auger 3300, and second burr 3100′ are biased away from the first burr 3100 by the action of the spring 3500.

In certain embodiments, the keyed element 2350 (FIG. 2) of the driveshaft comprises a slot in the distal end 2320 of the drive shaft, and the keyed element 3430 of the spindle comprises a bar which spans across the tubular portion of the spindle. When the spindle 3400 is slid over the driveshaft 2300, the slot 2350 of the drive shaft is configured to slidably receive the bar 3430, thus rotatively coupling the driveshaft 2300 and the spindle 3400.

In certain embodiments the retainer 3600 comprises a circlip which is interconnected at a distal portion 3402 of the spindle, which is distally offset from the bar 3430 of the spindle. The spring 3600 is placed between the circlip 3600 and the bar 3430 wherein the spring 3600 is captive, and compressed against the circlip 3600 when compressed by the driveshaft 2300.

In certain embodiments, shown in FIG. 1B-FIG. 2 and FIG. 7A-FIG. 8, an adjustment assembly 4000 is interconnected to the distal portion 3020 of the grinding assembly. The adjustment assembly 4000 comprises an adjustment knob 4100 on a distal end of the adjustment assembly where the rotation of the adjustment knob 4100 results in the movement of a thrust plate 4200 which is located at a proximal end 4010 of the adjustment assembly. The thrust plate 4200 moves longitudinally in a distal or proximal direction in relation to adjustment assembly 4000. The thrust plate 4200 is configured to interconnect with a distal face 3452 of the flange of the spindle wherein the thrust plate 4200 applies pressure to the spindle 3400. A 4300 between the thrust plate 4200 and the adjustment knob 4100 allows the rotation of the thrust plate 4200 independent of the adjustment knob 4100 wherein the thrust plate freely rotates with the rotation of the spindle 3400. The movement of the thrust plate 4200 serves to alternately compress and allow the extension of the spring 3500, thereby adjusting the distance of the second burr 3100′ from the first burr 3100, and thereby allowing a user to adjust the burr gap 3160 when the apparatus is on or off. When the adjustment knob 4100 is rotated in a first direction 4130, the thrust plate extends in a proximal direction 4135 and thereby compresses the spring 3500 and reduces the burr gap 3160. When the adjustment knob 4100 is rotated in a second direction 4140, the thrust plate extends in a distal direction 4145 and thereby allows the spring 3500 to extend to increase the burr gap 3160.

In certain embodiments the adjustment assembly 4000 is removable from the grinding assembly 3000. The removal of two bolts 4400 allows the removal of the adjustment assembly 4000 in certain embodiments. While alternate embodiments may require a different number of bolts 4400, or a different attachment strategy, it is an aspect of the present disclosure to allow the removal of the adjustment assembly 4000 from the grinding assembly 3000 without the use of specialized tools and as a single unit. When the adjustment assembly 4000 is removed from the grinding assembly 3000, if the adjustment knob 4100 remains unchanged, the location of the thrust plate 4300 remains unchanged. Thus, the removal and subsequent reinstallation of the adjustment assembly 4000 to the apparatus results in a burr gap 3160 identical to the burr gap 3160 prior to the removal of the adjustment assembly 4000. By allowing the separation of the adjustment assembly 4000 from the grinding assembly 3000 (e.g., as shown for instance in FIG. 2-FIG. 3) at a location that corresponds with the location of the first burr 3100 and the second burr 3100′, the user is able to remove adjustment assembly 4000 from the grinding assembly 3000 for operations (e.g., maintenance, and/or cleaning) without affecting the burr gap 3160 (e.g., as shown in FIG. 4C for instance). As illustrated in FIG. 2 for instance, the adjustment assembly 4000 is optionally configured to be removed from the grinding assembly in a location corresponding to the location of the burrs.

The attachment of the adjustment assembly 4000, such as with bolts 4400 as shown, ensures the adjustment assembly 4000 is attached at the same location and depth in relation to the grinding assembly 3000 each time it is removed and reconnected to the grinding assembly 3000.

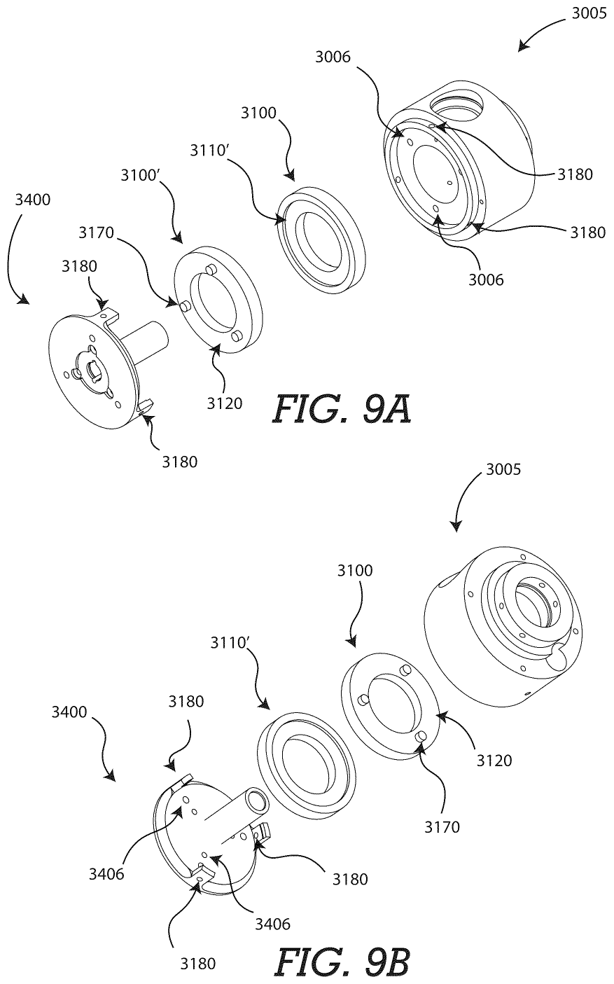

In certain embodiments, shown for instance in FIG. 9A-FIG. 9B, the first burr 3100 is interconnected to the grinding assembly 3000 through the use of magnetic connection between the grinding assembly (e.g., at one or more recesses 3006) and locator pins (e.g., pins 3170) interconnected to, and extending outward from, the mounting surface 3120 of the burrs. By using pins on the mounting surface of the burrs, the user is able to repeatedly and precisely remove and replace the burrs in relation to the apparatus. The pins 3170 extend axially outward from the mounting surfaces 3120 of the burrs wherein the pins 3170 are configured to engage recesses 3006 in the outer casing 3005 of the grinding assembly, and recesses 3406 in the proximal face 3451 of the spindle. When the pins 3170 of the first burr 3100 are inserted within the recesses 3006 of the outer casing, the first burr 3100 is rotatively constrained to the grinding assembly. When the pins 3170 of the second burr 3100′ are inserted into the recesses 3406 of the spindle, the second burr 3100′ is rotatively constrained to the spindle 3400. Embodiments wherein one or more pins 3170 comprises a magnet and embodiments wherein a recess comprises a magnet therein are each within the spirit and scope of the present disclosure. Furthermore, the action of the magnetic connection pulls the first burr 3100 into place to seat the first burr 3100, furthermore the action of the magnetic attracting pulls the second burr 3100′ into place to seat the second burr. In certain embodiments radial set screws 3180 configured to engage the outer perimeter of the first burr 3100 to further constrain the first burr 3100 rotationally, and radial set screws 3180 configured to engage the outer perimeter of the second burr 3100′ to further constrain the second burr 3100′ rotationally. Advancing the set screws 3180 inward further constrain the burrs 3100 in place rotationally and axially in relation to the grinding assembly 3000.

While various embodiments of the present disclosure have been described in detail, it is apparent that modifications and alterations of those embodiments will occur to those skilled in the art. However, it is to be expressly understood that such modifications and alterations are within the scope and spirit of the present disclosure. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. An apparatus configured to grind coffee beans comprising:
a first burr comprising an aperture through a central aspect of the first burr, wherein the aperture of the first burr comprises a diameter;
the first burr further comprises a cutting surface, and a mounting surface opposite the cutting surface, wherein the mounting surface of the first burr is oriented toward a driveline, and the cutting surface of the first burr is oriented away from the driveline;
a second burr comprising an aperture through a central aspect of the second burr, wherein the aperture of the first burr comprises a diameter;
the second burr further comprising a cutting surface facing the cutting surface of the first burr, and the second burr further comprising a mounting surface facing away from the cutting surface of the first burr, wherein the cutting surfaces are separated by a burr gap;
a spindle comprising an elongated portion extending from a first portion of the spindle toward a second portion of the spindle, wherein the elongated portion of the spindle is configured to extend through the aperture of the first burr, and through the aperture of the second burr;
the spindle further comprises a mounting feature at the second portion of the spindle configured to interconnect with the second burr, wherein the second burr is removably interconnected with the mounting feature;
an auger comprising configured to interconnect with the spindle wherein the auger and the spindle are rotativity interconnected, wherein rotation of the driveline results in the rotation of the spindle, the auger, and the second burr, and wherein the rotation of the auger is configured to advance material toward the first burr and second burr for grinding.

2. The apparatus of claim 1 further comprising:
an adjustment assembly comprising a thrust plate configured to interface with the second portion of the spindle, wherein the thrust plate rotates freely in relation to the adjustment assembly.

3. The apparatus of claim 2, wherein the adjustment assembly is configured to be removably interconnected to the apparatus at a location corresponding to the location of the burrs.

4. The apparatus of claim 2, further comprising:
the adjustment assembly comprises an adjustment knob at a distal portion, wherein the rotation of the adjustment knob in a first direction is configured to advance the thrust plate toward the burrs, and the rotation of the adjustment knob in a second direction is configured to retract the thrust plate away from the burrs.

5. The apparatus of claim 4, further comprising:
a driveshaft interconnected to the driveline, wherein the driveshaft is configured to rotate the spindle; and
a spring disposed between a first end of the driveshaft and the spindle, wherein the spring is configured to push the second burr away from the first burr.

6. The apparatus of claim 5, wherein when the thrust plate is advanced toward the burrs, the thrust plate applies a force to second portion of the spindle, thereby compressing the spring and reducing the burr gap, and
wherein when the thrust plate is retracted away from the burrs, the spring expands and increases the burr gap.

7. The apparatus of claim 4, wherein the second portion of the spindle further comprises a flange which extends radially outward from the second portion of the spindle, and wherein the thrust plate interfaces with a distal face of the flange.

8. The apparatus of claim 1 further comprising a pre-breaking chamber having a pathway therethrough, wherein the auger is configured to carry material through the pre-breaking chamber from an input port, through the pre-breaking chamber, and to the burrs for grinding.

9. The apparatus of claim 8, wherein the input port is configured in a gravity fed configuration, and the pathway of the pre-breaking chamber is configured in a lateral configuration.

10. The apparatus of claim 8, wherein the auger is eccentrically located in relation to the pathway of the pre-breaking chamber.

11. The apparatus of claim 10, wherein the auger is axially offset toward a bottom aspect of the pathway of the pre-breaking chamber.

12. The apparatus of claim 1, wherein the auger is removably interconnected with the spindle.

13. The apparatus of claim 12, wherein the auger is configured to slidably interconnect with the first portion of the spindle.

14. The apparatus of claim 1, wherein at least one of the first burr and the second burr are removably interconnected with the apparatus.

15. The apparatus of claim 1, wherein the first burr and the second burr are removably interconnected with the apparatus, wherein the first burr comprises at least one locator pin extending outward from the mounting surface of the first burr which is configured to interconnect with a recess of the grinding assembly; and/or
the second burr comprises at least one locator pin extending outward from the mounting surface of the second burr which is configured to interconnect with a recess of the spindle.

16. The apparatus of claim 15, wherein the interconnection between at least one of the at least one locator pins of the burrs, and at least one of the recesses, comprises a magnetic connection.

17. The apparatus of claim 1, wherein the first burr and the second burr are removably interconnected with the apparatus, wherein the first burr comprises a plurality of locator pins extending outward from the mounting surface of the first burr, which are configured to interconnect with a plurality of recesses of the grinding assembly; and
the second burr comprises a plurality of locator pins extending outward from the mounting surface of the second burr, which are configured to interconnect with a plurality of recesses of the spindle.

18. The apparatus of claim 17, wherein the interconnection between the plurality of locator pins of the burrs, and the plurality of the recesses, of the grinding assembly and the spindle, comprises a magnetic connection.

19. An apparatus configured to grind coffee beans comprising:
a driveline comprising a motor, and a gearbox;
a first burr comprising an aperture through a central aspect of the first burr, wherein the aperture of the first burr comprises a diameter;
the first burr further comprises a cutting surface, and a mounting surface opposite the cutting surface, wherein the mounting surface of the first burr is oriented toward the driveline and a mounting of the first burr is oriented away from the driveline;
the first burr further comprises a plurality of magnetic pins interconnected to the mounting surface of the first burr, wherein each of the magnetic pins are configured to insert into a plurality of recesses, thereby restricting rotation of the first burr;
a second burr comprising an aperture through a central aspect of the second burr, wherein the aperture of the first burr comprises a diameter;
the second burr further comprising a cutting surface facing the cutting surface of the first burr, and the second burr further comprising a mounting surface facing away from the first burr, wherein the cutting surfaces are separated by a burr gap;
a driveshaft comprising an elongated axial form, wherein the driveshaft comprises a first end interconnected with the driveline, and wherein the driveshaft extends through the aperture of the first burr;
a spindle comprising a generally tubular portion extending from a first end of the spindle toward a second end of the spindle, wherein an inner aspect of the spindle is interconnected to an outer aspect of the driveshaft, the tubular portion of the spindle comprises an internal surface configured to slidably receive an external surface of the driveshaft therein;
the spindle further comprises a flange extending radially outward from the second end of the spindle, wherein the mounting surface of the second burr is interconnected to a proximal surface of the flange of the spindle, and wherein the flange comprises a diameter greater than the diameter of the aperture of the second burr;
a spring is disposed between the first end of the driveshaft and the driveline, wherein the spring is configured to push the second burr away from the first burr;
an auger comprising a tubular form interconnected with the spindle wherein an inner aspect of the auger is interconnected with an outer aspect of the tubular portion of the spindle, wherein the rotation of the driveline results in the rotation of the spindle, the auger, and the second burr, and wherein the rotation of the auger is configured to advance material toward the first burr and second burr;
an adjustment assembly comprising a thrust plate configured to interface with a distal face of the flange of the spindle, wherein the thrust plate rotates freely with the spindle in relation to the adjustment assembly;
the adjustment assembly comprises an adjustment knob at a distal portion, wherein the rotation of the adjustment knob in a first direction advances the thrust plate toward the burrs, and the rotation of the adjustment knob in a second direction retracts the thrust plate away from the burrs,
wherein when the thrust plate is advanced toward the burrs, the thrust plate applies a force to a distal surface of the flange of the spindle, thereby compressing the spring and reducing the burr gap, and
wherein when the thrust plate is retracted away from the burrs, the spring expands and increases the burr gap.
